(19) United States
(12) Patent Application Publication
(10) Pub. No.: US 2021/0060708 A1
(43) Pub. Date: Mar. 4, 2021

(54) METHOD OF FORMING THROUGH HOLE

(71) Applicant: AISIN SEIKI KABUSHIKI KAISHA, Kariya-shi (JP)

(72) Inventor: Taisuke NAITO, Kariya-shi (JP)

(73) Assignee: AISIN SEIKI KABUSHIKI KAISHA, Kariya-shi (JP)

(21) Appl. No.: 16/892,408

(22) Filed: Jun. 4, 2020

(30) Foreign Application Priority Data
Aug. 30, 2019 (JP) 2019-158183

(51) Int. Cl. B23K 26/384; B23K 26/386

(52) U.S. Cl. CPC B23K 26/384; B23K 26/386

(57) ABSTRACT

A method of forming a through hole, wherein a spot of a laser light scans along a predetermined path and forms a through hole includes a first process in which the spot of the laser light circulates along an inner path from a predetermined first point on the inner path and reaches a predetermined second point. The inner path is positioned at an inner side relative to an outer path. The predetermined second point is positioned before the spot of the laser light returns to the predetermined first point. The method includes a second process in which the spot of the laser light moves along a transition path and reaches a predetermined third point on the outer path. The method includes a third process in which the spot of the laser light circulates along the outer path from the predetermined third point and returns to the predetermined third point.

### CROSS REFERENCE TO RELATED APPLICATIONS

This application is based on and claims priority under 35 U.S.C. § 119 to Japanese Patent Application 2019-158183, filed on Aug. 30, 2019, the entire content of which is incorporated herein by reference.

### TECHNICAL FIELD

This disclosure generally relates to a method of forming a through hole.

### BACKGROUND DISCUSSION

For example, JP2006-247660A (which will be hereinafter referred to as Patent reference 1) discloses a known method of forming a circular through hole on a plate material by scanning a surface of the plate material with a spot of a laser light along a predetermined path on the surface of the plate material. In Patent reference 1, the spot of the laser light scans along a circular inner path arranged to be coaxial (concentric) with an outer path before the spot of the laser light scans along the outer path corresponding to an inner peripheral edge of the through hole. That is, the spot of the laser light circulates from a predetermined first point on the inner path along the inner path and returns to the first point. Thus, a portion including a disc shape is cut off from the plate material (a first process). The portion cut off in the first process is called a first scrap. Next, from a predetermined second point on the outer path, the spot of the laser light circulates along the outer path and returns to the second point. Thus, a portion including a ring shape is cut off from the plate material. Consequently, a through hole, which is an objective, is formed (a second process). The portion cut off in the second process is called a second scrap.

Since the spot of the laser light scans along the inner path in the first process, an inner peripheral side of the outer path which is positioned in the vicinity of the inner path becomes higher in temperature than an outer peripheral side. In a case where the laser light scans along the outer path in this state, burr (dross) is likely to occur at an outer peripheral edge of the second scrap, and the burr (dross) is not likely to occur at an inner peripheral edge of the through hole. In a case where a large amount of burr (dross) is generated at the inner peripheral edge of the through hole, a lot of workload or man-hour is spent to perform a finishing process for removing the burr (dross). However, by applying the known method of forming a through hole according to Patent reference 1, the above-mentioned finishing process can be reduced (or omitted).

From a viewpoint of enhancement in productivity of a product, it is ideal that the workload spent on the removal (collection) of the scraps is reduced as much as possible. In a case where the known method of forming a through hole according to Patent reference 1 is employed, the two scraps (the first scrap and the second scrap) are generated when one through hole is formed. Accordingly, in this case, the number of scraps is large and the productivity of the product might decrease.

A need thus exists for a method of forming a through hole, which is not susceptible to the drawback mentioned above.

### SUMMARY

According to an aspect of this disclosure, a method of forming a through hole, wherein a spot of a laser light scans along a predetermined path of a surface of a plate material and forms a through hole on the plate material, includes a first process in which the spot of the laser light circulates along an inner path from a predetermined first point on the inner path and reaches a predetermined second point. The inner path is positioned at an inner side by a predetermined distance relative to an outer path corresponding to an inner peripheral edge of the through hole, and the predetermined second point is positioned before the spot of the laser light returns to the predetermined first point. The method includes a second process in which the spot of the laser light moves along a transition path extended from the predetermined second point towards the outer path and reaches a predetermined third point on the outer path. The method includes a third process in which the spot of the laser light circulates along the outer path from the predetermined third point and returns to the predetermined third point.

### BRIEF DESCRIPTION OF THE DRAWINGS

The foregoing and additional features and characteristics of this disclosure will become more apparent from the following detailed description considered with the reference to the accompanying drawings, wherein:

FIG. 1A is a perspective view of a door frame for a vehicle which includes a through hole formed by using a method of forming a through hole related to an embodiment disclosed here;

FIG. 1B is a cross-sectional view of the door frame for a vehicle of FIG. 1A;

FIG. 2 is a scanning path diagram of a spot of a laser light according to the embodiment;

FIG. 3 is an enlarged view of the vicinity of a second point and a third point, of the scanning path diagram of FIG. 2;

FIG. 4 is an enlarged view of the vicinity of a second point and a third point, of a scanning path diagram according to a comparative example; and

FIG. 5 is a scanning path diagram of a spot of a laser light according to a variation of the embodiment.

### DETAILED DESCRIPTION

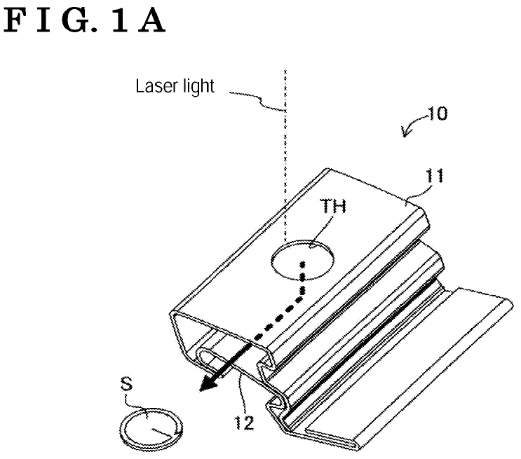

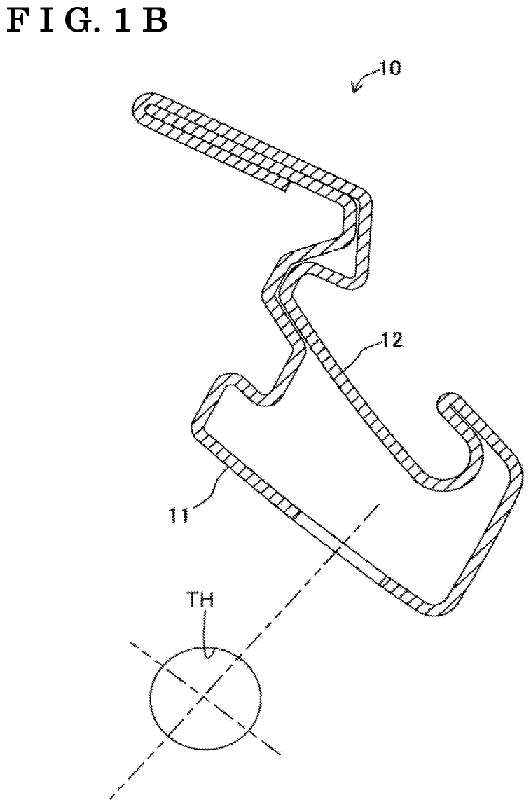

A method of forming a through hole, the method according to an embodiment disclosed here will be described. Specifically, processes of forming a through hole TH (refer to FIGS. 1A and 1B) including a circular shape on a door frame 10 for a vehicle will be described. The door frame 10 for a vehicle is manufactured as follows. First, a tubular member extended linearly is manufactured from a plate material including a band shape with the use of a known roll forming method. Next, a bending process is performed so that the tubular member is bent to include a bow shape following along an upper edge portion of an entry and exit opening of a vehicle. The door frame 10 for a vehicle that is manufactured in the above-described way includes a cross section orthogonal to a lengthwise direction of the frame 10, the cross section which includes a substantially rectangular shape as illustrated in FIGS. 1A and 1B. That is, the door frame 10 for a vehicle includes an inner wall portion 11 positioned at an inner side of a vehicle cabin and an outer wall portion 12 positioned at an outer side of the vehicle cabin as illustrated in the drawings. That is, the inner wall portion 11 and the outer wall portion 12 are arranged to face or oppose each other. A plate thickness of the plate material is 0.9 mm, for example.

Next, the process of forming the circular through hole TH on the inner wall portion 11 will be described. A diameter of the through hole TH is 8 mm, for example.

First, a laser irradiation apparatus is arranged in the vicinity of the inner wall portion 11. The laser irradiation apparatus is attached to a known robot arm and is moved by the robot arm in a direction which is parallel to a surface of the inner wall portion 11. That is, a spot of a laser light scans the surface of the inner wall portion 11 along a path R, which is a predetermined path, of the surface of the inner wall portion 11, as will be described later. The surface of the inner wall portion 11 is planar. An optical axis of the laser light is orthogonal to the surface of the inner wall portion 11 through the entire scanning process of the laser light. A spot diameter of the laser light is 0.05 mm in the embodiment.

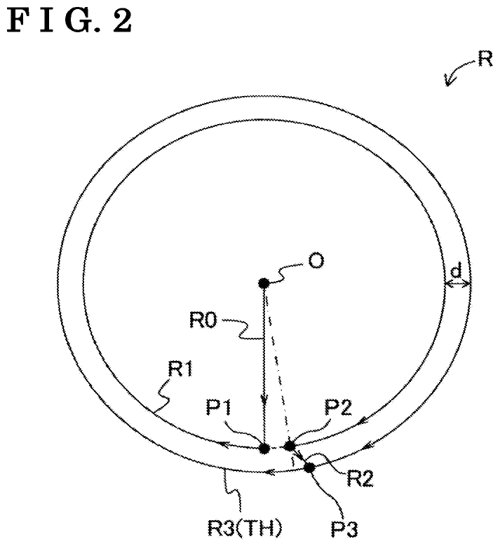

As illustrated in FIG. 2, the path R includes a preliminary path R0, an inner path R1, a transition path R2 and an outer path R3. The preliminary path R0 corresponds to a linear portion from a center O of the through hole TH to a first point P1, which is a predetermined point. A length of the preliminary path R0 (a distance from the center O to the first point P1) is 3.5 mm in the embodiment.

The inner path or inner circular route R1 corresponds to a portion arranged to circulate about the center O from the first point 1 and reach a second point P2 corresponding to a point arranged immediately before returning to the first point P1. The inner path R1 includes an arc shape (a substantially annular shape). A moving direction on the inner path R1 is the clockwise direction as illustrated in FIG. 2. A radius of the inner path R1 is identical to the length of the length of the preliminary path R0. A distance (a direct distance) from the first point P1 to the second point P2 is 0.5 mm in the embodiment.

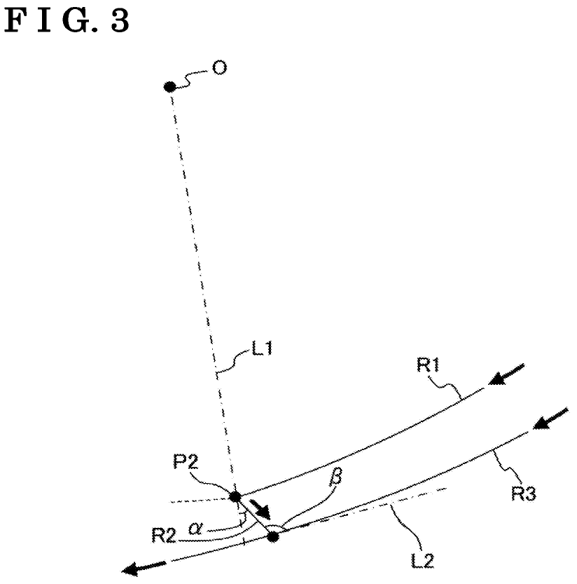

The transition path or route R2 is a linear portion arranged from the second point P2 of the inner path R1 to reach a third point P3 on the outer path R3 which will be described below. The transition path R2 is provided to extend linearly towards a side opposite to the moving direction (that is, the clockwise direction) on the inner path R1 and towards an outer side of the inner path R1. An angle α formed between a straight line L1 connecting the center O and the second point P2 to each other, and the transition path R2 is 30 degrees, for example (refer to FIG. 3).

The outer path or outer circular route R3 coincides with an inner peripheral edge of the through hole TH. That is, the outer path R3 includes a circular shape and a diameter of the outer path R3 is 8 mm in the embodiment (which is identical to an inner diameter of the through hole TH). As illustrated in FIG. 2, the transition path R2 and the outer path R3 intersect each other or meet with each other, and the intersection point is referred to as the third point P3. The outer path R3 is an annular portion arranged to circulate about the center O from the third point 3 and return to the third point 3, and includes an annular shape. A moving direction on the outer path R3 is the clockwise direction as illustrated in FIG. 2.

As described above, the inner path R1 and the outer path R3 are arranged to be coaxial with each other, and a distance d (i.e., a predetermined distance) between the inner path R1 and the outer path R3 (a difference between the radiuses of the inner path R1 and the outer path R3) is 0.5 mm in the embodiment. The distance d from the inner path R1 to the outer path R3 is set to be equal to or less than the plate thickness (=0.9 mm).

The spot of the laser light is scanned along the above-described path R. That is, first, the laser light is irradiated at the center O. Then, the spot of the laser light scans towards the first point P1 along the preliminary path R0 (a preliminary process). Next, the spot of the laser light scans (circulates or moves) from the first point P1 towards the second point P2 along the inner path R1 in the clockwise direction in FIG. 2 (a first process).

Next, the spot of the laser light scans from the second point P2, which is immediately before returning to the first point P1, to the third point P3 along the transition path R2 (a second process).

Next, the spot of the laser scans (circulates) from the third point P3 along the outer path R3 in the clockwise direction in FIG. 2 and returns to the third point P3 (a third process). Accordingly, a portion of the inner wall portion 11, the portion which is positioned at an inner side of the outer path R3, is cut off. That is, the through hole TH is formed. A scanning speed of the spot of the laser light in the preliminary process, the first process, and the second process is 3.0 m/min in the embodiment. A scanning speed of the spot of the laser light in the third process is 1.0 m/min in the embodiment. Intensity (output) of the laser light in the preliminary process, the first process and the second process is 250 W in the embodiment. Intensity (output) of the laser light in the third process is 150 W in the embodiment. The above-described scannings of the laser light spot (from the preliminary process to the third process) are performed continuously. The portion cut off in the above-described manner is called a scrap S (refer to FIG. 1A).

In the first process, as the spot of the laser light scans along the inner path R1, an inner peripheral side of the outer path R3 which is positioned in the vicinity of the inner path R1 becomes high in temperature compared to an outer peripheral side. In a case where the laser light scans along the outer path R3 in this state, burr (dross) is likely to occur at an outer peripheral edge of the scrap S, and the burr (dross) is not likely to occur at an inner peripheral edge of the through hole TH. In each of the processes, compressed air is blown to the irradiation position of the spot. Thus, the portion of the inner wall portion 11, the portion at which the laser light is irradiated (that is, the position of the spot) is brought to a melting point in a short time or quickly, and heat input to a region around the portion is minimized.

As described above, by employing the method of forming a through hole according to the embodiment, one scrap S is generated when forming one through hole TH (refer to FIG. 1A), unlike the above-mentioned known method of forming a through hole. That is, the first scrap including a disc shape and the second scrap including a ring shape are generated in the above-mentioned known method of forming a through hole. In contrast, in the embodiment, the spot of the laser light is allowed to circulate or move along the inner path R1 from the first point P1 and, without returning to the first point P1, allowed to move from the second point P2 immediately before the first point P1 to the outer path R3 via the transition path R2. Finally, the spot of the laser light circulates along the outer path R3. Thus, the scrap S of the embodiment is in a state where the first position P1 and the second portion P2 are connected or joined to each other, but not in a state where the portion corresponding to the first scrap including the disk shape and the portion corresponding to the second scrap including the ring shape are separated from each other as in the above-mentioned known method of forming a through hole. Accordingly, the number of the scrap S is smaller than (a half of) a case in which the above-mentioned known method of forming a through hole is used. Accordingly, workload or man-hour for removing (collecting) the scrap S is reduced. Consequently, productivity of the product is enhanced according to the embodiment.

The distance d between the inner path R1 and the outer path R3 is set to be substantially a half of the plate thickness in the embodiment. Accordingly, if the intensity (output) of the laser light is relatively small, the burr (dross) is restricted from occurring at the inner peripheral side of the through hole TH. Accordingly, a relatively inexpensive laser irradiation apparatus can be used. In such a case where the intensity of the laser light is relatively small, the outer wall portion 12 suffers little influence by the laser light (very few or almost no burn marks by the laser light), and accordingly an outer appearance of the door frame 10 for a vehicle is maintained appropriately.

As described above, the transition path R2 is provided to extend from the second point P2 towards the side that is opposite to the moving direction of the laser light spot on the inner path R1 and towards the outer side of the inner path R1. Thus, a crossing angle □ of an end portion of the transition path R2 and an end portion of the outer path R3 is larger than 90 degrees (refer to FIG. 3). The crossing angle or intersection angle □ corresponds to an angle formed between the moving direction (vector) at an end of the transition path R2 (that is, the third point P3) and the moving direction (vector) at an end of the outer path R3 (that is, the third point P3). That is, an angle formed between the transition path R2 and a tangent line L2 at the third point P3 of the outer path R3 is larger than 90 degrees.

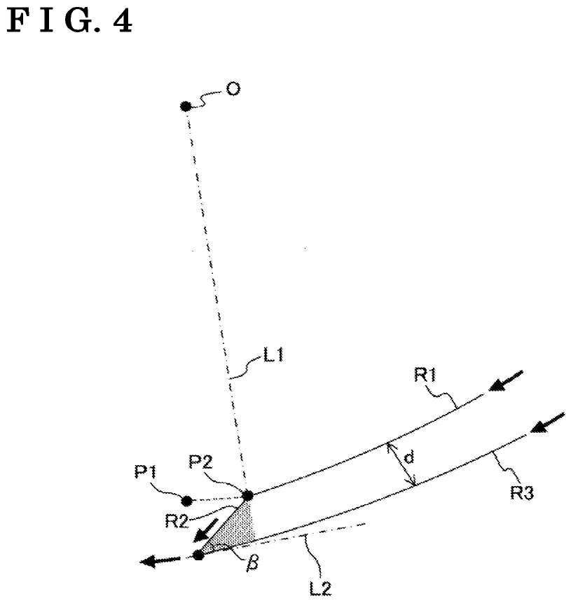

As illustrated in FIG. 4 as a comparative example, if the transition path R2 is provided to extend from the second point P2 towards a direction that is identical to the moving direction on the inner path R1 and towards the outer side of the inner path R1, the crossing angle □ will be smaller than 90 degrees. In this case, energy of the laser light tends to concentrate on a region A (the shaded portion in FIG. 4) when the spot of the laser light approaches the end portion of the outer path R3 in the third process. The region A is a narrow region formed between a portion cut along the transition path R2 in the second process prior to the third process and the end portion of the outer path R3, and includes a small width. Accordingly, the region A is likely to be overheated, which might affect the finishing of the through hole TH adversely (circularity or roundness of the through hole TH and/or smoothness of the inner peripheral surface of the through hole TH, for example).

In contrast, according to the embodiment disclosed here, the crossing angle □ is set to be larger than 90 degrees, and thus the narrow region A described in the above-mentioned comparative example does not exist at the inner side of the end portion of the outer path R3 (refer to FIG. 3). Consequently, the finish of the through hole TH is maintained appropriately.

Implementation of the present disclosure is not limited to the above-described embodiment and may be changed or modified in various ways without departing from the objective of the disclosure.

For example, the above-described embodiment explains the method of forming the through hole TH including a circular shape, however, the present disclosure is applicable to a method of forming a through hole including a polygonal shape, an oval shape, an elliptical shape and an elongated circular shape, for example. In this case, first, the spot of the laser light scans along the inner path R1 arranged at an inner side relative to the outer path R3 corresponding to the inner peripheral edge (sides) of the above-mentioned through hole by the distance d that is substantially a half of the plate thickness. Then, the spot of the laser light moves or transitions to the outer path R3 via the transition path R2, and scans along the outer path R3.

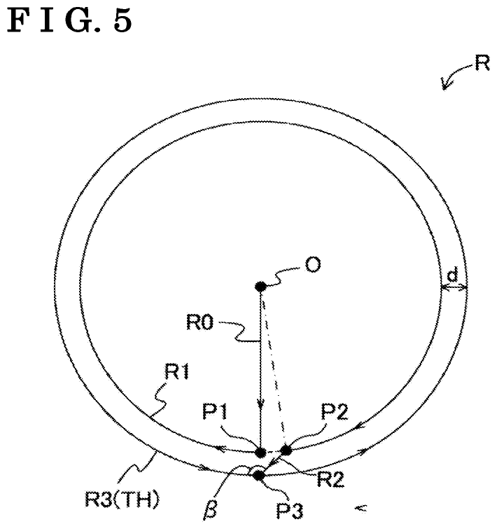

The scanning directions of the laser light spot on the inner path R1 and on the outer path R3 in the above-described embodiment are set to be the clockwise direction, however, the scanning directions may be the counter-clockwise direction. Alternatively, the scanning direction on the inner path R1 and the scanning direction on the outer path R3 may be the opposite directions to each other (refer to FIG. 5 illustrating a variation of the embodiment). In this case, a start portion of the inner path R1 and the end portion of the outer path R3 face or oppose to each other. Accordingly, a time period from the scanning of the start portion of the inner path R1 to the scanning of the end portion of the outer path R3 is longer than the above-described embodiment. Thus, the temperature of the end portion of the outer path R3 may have lowered when the portion is scanned. Therefore, the intensity of the laser light scanning the start portion of the inner path R1 is set be slightly higher than the intensity of the laser light scanning the end portion of the inner path R1, so that the temperature of the start portion-side of the inner path R1 (the end portion-side of the outer path R3) is set to be higher than the temperature of the end portion-side of the inner path R1 (the start portion-side of the outer path R3). In a case where the intensity of the laser light in the first process is kept at a constant intensity in a similar manner to the above-described embodiment, the inner path R1 may be set in a spiral configuration, wherein the distance d between the start point-side of the inner path R1 and the end portion-side of the outer path R3 is set relatively small, and the distance d between the end portion-side of the inner path R1 and the start portion-side of the outer path R3 is set relatively large.

In a case where the crossing angle □ is smaller than 90 degrees as in the example illustrated in FIG. 4, an appropriate finishing of the through hole TH is maintained by gradually reducing the intensity of the laser light at the end portion of the outer path R3.

According to the aforementioned embodiment, the method of forming a through hole, wherein the spot of the laser light scans along the predetermined path R of the surface of the plate material and forms the through hole TH on the plate material, includes the first process in which the spot of the laser light circulates along the inner path R1 from the first point P1 on the inner path R1 and reaches the second point P2 (i.e., predetermined second point). The inner path R1 is positioned at the inner side by the distance d relative to the outer path R3 corresponding to the inner peripheral edge of the through hole TH. The second point P2 is positioned before the spot of the laser light returns to the predetermined first point P1. The method includes the second process in which the spot of the laser light moves along the transition path R2 extended from the second point P2 towards the outer path R3 and reaches the third point P3 (i.e., predetermined third point) on the outer path R3. The method includes the third process in which the spot of the laser light circulates along the outer path R3) from the third point P3 and returns to the third point P3.

According to the above-described configuration, only one scrap S is generated when forming one through hole TH. That is, the scrap S of the embodiment is in a state where the first position P1 and the second portion P2 are connected or joined to each other, but not in a state where the portion corresponding to the first scrap including the disc shape and the portion corresponding to the second scrap including the ring shape are separated from each other as in the above-mentioned known method of forming a through hole. Accordingly, the number of the scrap S generated when one through hole TH is formed is smaller than a case in which the above-mentioned known method of forming a through hole is used (the number of the scrap S in the embodiment is one-half of the above-mentioned known method). Accordingly, the workload for removing (collecting) the scrap S is reduced. Consequently, the productivity of the product is enhanced according to the embodiment.

According to the aforementioned embodiment, the distance d is smaller than the plate thickness of the plate material.

According to the aforementioned embodiment, the crossing angle □ of the end portion of the transition path R2 and the end portion of the outer path R3 is equal to or larger than 90 degrees.

According to the aforementioned embodiment, the circulation direction (the moving direction) of the spot of the laser light in the first process and the circulation direction (the moving direction) of the spot of the laser light in the third process are same as each other.

According to the aforementioned embodiment, the distance d between the inner path R1 and the outer path R3 is set to be a half of the plate thickness of the plate material.

According to the aforementioned embodiment, the transition path R2 is provided to extend from the predetermined second point P2 towards the side opposite to the moving direction on the inner path R1 and towards the outer side of the inner path R1.

According to the aforementioned embodiment, the crossing angle □ (i.e. angle) between the transition path R2 and the tangent line L2 at the third point P3 of the outer path R3 is larger than 90 degrees.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A method of forming a through hole, wherein a spot of a laser light scans along a predetermined path of a surface of a plate material and forms a through hole on the plate material, the method comprising:
a first process in which the spot of the laser light circulates along an inner path from a predetermined first point on the inner path and reaches a predetermined second point, the inner path being positioned at an inner side by a predetermined distance relative to an outer path corresponding to an inner peripheral edge of the through hole, the predetermined second point being positioned before the spot of the laser light returns to the predetermined first point;
a second process in which the spot of the laser light moves along a transition path extended from the predetermined second point towards the outer path and reaches a predetermined third point on the outer path; and
a third process in which the spot of the laser light circulates along the outer path from the predetermined third point and returns to the predetermined third point.

2. The method of forming a through hole according to claim 1, wherein the predetermined distance is smaller than a plate thickness of the plate material.

3. The method of forming a through hole according to claim 1, wherein a crossing angle of an end portion of the transition path and an end portion of the outer path is equal to or larger than 90 degrees.

4. The method of forming a through hole according to claim 1, wherein a circulation direction of the spot of the laser light in the first process and a circulation direction of the spot of the laser light in the third process are same as each other.

5. The method of forming a through hole according to claim 1, wherein the predetermined distance between the inner path and the outer path is set to be a half of a plate thickness of the plate material.

6. The method of forming a through hole according to claim 1, wherein the transition path is provided to extend from the predetermined second point towards a side opposite to a moving direction on the inner path and towards an outer side of the inner path.

7. The method of forming a through hole according to claim 1, wherein an angle between the transition path and a tangent line at the predetermined third point of the outer path is larger than 90 degrees.
